(19) United States
(12) Patent Application Publication
(10) Pub. No.: US 2026/0193556 A1
(43) Pub. Date: Jul. 9, 2026

(54) NATURAL GAS CONDENSATE PROCESSING

(71) Applicant: NUOVO PIGNONE TECNOLOGIE - S.R.L., Florence (IT)

(72) Inventor: Jochen BILDESHEIM, Frankfurt, Hesse (DE)

(21) Appl. No.: 19/134,049

(22) PCT Filed: Dec. 6, 2023
(86) PCT No.: PCT/EP2023/025512

§ 371 Date: May 29, 2025

(30) Foreign Application Priority Data
Dec. 7, 2022 (IT) 102022000025143

(51) Int. Cl. C10L 3/10

(52) U.S. Cl. CPC C10L 3/106; C10L 2290/06; C10L 2290/08; C10L 2290/10; C10L 2290/46; C10L 2290/547; C10L 2290/58

(57) ABSTRACT

A method and a system for processing a natural gas stream are disclosed herein. In particular, the subject matter disclosed herein is directed to a method and a system for processing a partially condensed natural gas stream wherein the method and system do not comprise a separate heavy hydrocarbon condensate treatment section. The method and system comprise separating a condensate stream from a non-condensed light hydrocarbon vapor stream, increasing the energy of the condensate stream and/or the light hydrocarbon vapor stream and re-injecting the condensate stream into the light hydrocarbon vapor stream, so that the condensates can be subsequently treated together with the light hydrocarbons. Subsequent treatments include free water removal, the temperature of the natural gas stream downstream re-injection being controlled to remain above the natural gas stream dew point.

### TECHNICAL FIELD

The present disclosure concerns natural gas processing. Embodiments disclosed herein specifically concern a natural gas processing method wherein hydrocarbon condensed in a natural gas pipeline or during gas compression is processed before undergoing treatments including free water removal, drying, mercury removal and natural gas filtering. Also disclosed herein is a system for processing natural gas condensate by reducing investment costs.

### BACKGROUND ART

Heavy hydrocarbons often condense in natural gas pipelines or during gas compression. The amount of hydrocarbons condensate, as well as the amount of water condensate, depends on natural gas compositions, pressure and temperature. Several scenarios can occur during gas pipelines operation. Pressure drop, heat transfer between soil and gas, flow, type of land and network topology are critical aspects.

According to the current art, in natural gas processing plants the condensates are treated separately from the gas stream. A separator is present to separate a gas/vapor fraction from the condensates. Moreover, when the temperature is below the water dew point, the separator is configured to additionally separate the heavier water condensate from the hydrocarbon condensate. The separated hydrocarbon condensate is subsequently separately treated before being sent to storage or to a fractionation unit. Specific required treatment steps depend on the product specifications.

For example, hydrocarbon condensate treatment steps may involve residual free water removal, drying, mercury adsorption, filtering and condensate stripping, to obtain a stabilized hydrocarbon condensate and a vapor fraction that is routed back to the three-phase separator. While the treatment steps of the gas/vapor fraction from the separator may include compression, cooling, separation in a second separator (called knockout drum), drying, mercury adsorption and filtering, before routing the remained gas stream to the final intended use.

Such approaches negatively affect the costs of the system, in terms of capital expenditure costs and overall footprint, due to the need to provide for a big number of equipment.

Accordingly, an improved method and system for natural gas condensate processing to address the issues of complexity and costs of the methods and systems of the current art would be beneficial and would be welcome in the technology. More in general, it would be desirable to provide methods and systems adapted to more efficiently address problems entailed by hydrocarbon condensation due to increasing pressure and/or reducing temperatures in a system comprising a natural gas stream.

### SUMMARY

In one aspect, the subject matter disclosed herein is directed to a natural gas processing method wherein hydrocarbons condensed in a natural gas pipeline or during gas compression are separated, as a condensate stream, comprised of heavy hydrocarbons and amounts of other components, such as, in particular, water, from a non-condensed light hydrocarbon vapor stream, to be re-injected into the non-condensed light hydrocarbon vapor stream after the light hydrocarbon vapor stream has been compressed and/or the condensate stream has been heated or even vaporized. In particular, the condensate stream is re-injected into the light hydrocarbon vapor stream before treatments preliminary to storage or fractionation thereof. Such treatments can include, for example, free water removal, drying, mercury removal and hydrocarbon filtering. The natural gas processing method comprises controlling the temperature of the natural gas stream after re-injection and, if the temperature is below the natural gas dew point, then increasing the energy of the system by compressing the light hydrocarbon vapor stream and/or heating or even vaporizing the condensate stream before re-injecting it into the light hydrocarbon vapor stream.

A further aspect of the present disclosure is drawn to a natural gas processing system including a separator, to separate a light hydrocarbon vapor stream and a condensate stream, a gas compressor adapted to compress the light hydrocarbon vapor stream and/or a heater adapted to heat the condensate stream, a pump adapted to re-inject the condensate stream into the light hydrocarbon vapor stream at the suction or discharge side of the gas compressor and a temperature control, configured to operate the gas compressor and/or the heater. In particular, the separator is configured to additionally separate the heavier water condensate from the hydrocarbon condensate, when the temperature is below the water dew point. Moreover, the natural gas processing system can include a heater for heating the condensate stream before re-injecting it into the light hydrocarbon vapor stream.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a schematic of a system for processing natural gas, according to an embodiment of the present disclosure; and

FIG. 2 illustrate a flow chart of a method for processing natural gas according to the present disclosure.

### DETAILED DESCRIPTION OF EMBODIMENTS

According to one aspect, the present subject matter is directed to a method and a system for processing a natural gas stream, following condensation of a fraction of the natural gas stream, as a consequence of pressure drop and/or cooling of the stream.

According to another aspect, the subject matter disclosed herein is directed to a method and a system for processing a partially condensed natural gas stream by separating a condensate stream from a non-condensed light hydrocarbon vapor stream, increasing the energy of the light hydrocarbon vapor or the condensate stream and re-injecting the condensate stream into the light hydrocarbon vapor stream, before treating and subsequent storing and or fractionation of the natural gas stream. The temperature of the natural gas stream downstream the re-injection of the condensate stream into the light hydrocarbon vapor stream is controlled to remain above the natural gas stream dew point. If the temperature is lower than the natural gas stream dew point, then the condensate stream is heated before re-injection into the light hydrocarbon vapor stream. In particular, heating of the condensate stream can also comprise vaporizing at least part of the condensate stream before re-injecting it into the light hydrocarbon vapor stream.

Moreover, according to another aspect, if the temperature of the natural gas stream downstream the re-injection of the condensate stream into the light hydrocarbon vapor stream is higher than 10° C. above the natural gas dew point, then the natural gas stream downstream the re-injection point is cooled.

According to an aspect, the treatments following re-injection of the condensate stream into the light hydrocarbon vapor stream, before storing and or fractionation of the natural gas stream, can include free water removal, drying, mercury adsorption, filtering, and condensate stripping.

Specifically, a natural gas processing system is disclosed herein, the system including a two or three-phase separator adapted to separate a natural gas stream into a light hydrocarbon vapor stream and a condensate stream or into a light hydrocarbon vapor stream, a heavy hydrocarbon condensate stream and a water stream; a gas compressor to compress the light hydrocarbon vapor stream and/or a heater to heat the condensate stream, and a pump to re-inject the heavy hydrocarbon condensate stream into the light hydrocarbon vapor stream. The system can also comprise a vaporizer, to vaporize the condensate stream upstream re-injecting it into the light hydrocarbon vapor stream. Downstream the re-injection point, the natural gas processing system comprises a temperature control adapted to maintain the temperature of the natural gas stream above the natural gas dew point, by operating the gas compressor, the heater and/or the vaporizer.

According to one aspect, downstream the re-injection point, the natural gas processing system comprises a treatment section, upstream a storage system or a fractionation unit, and the treatment section includes a knock out drum, to separate residual water, and can include a dryer, an adsorber adapted to adsorb mercury eventually present in the stream, a filter.

According to one aspect, the heated or even at least partly vaporized condensate stream can be re-injected alternatively into the suction or discharge side of the gas compressor. Moreover, the knock out drum of the treatment section is operated below the water dew point. A cooler can be present downstream the re-injection point, for cooling the natural gas stream in case its temperature is higher than the water dew point.

According to a more general aspect, disclosed herein is an improved method and a system for processing and at least partly condensed natural gas stream, wherein the method and system do not comprise a separate condensate treatment section, except for an optional heat exchange step and unit adapted to heat or even vaporize the condensate before re-injecting it into the non-condensed natural gas fraction, so that the condensate can be subsequently treated together with the light hydrocarbons. In particular, the method and system for processing and at least partly condensed natural gas stream comprises separating a light hydrocarbon vapor stream and a condensate stream, increasing the energy of the light hydrocarbon vapor stream or the condensate stream and re-injecting the condensate stream into the light hydrocarbon vapor stream, before treating and subsequent storing and or fractionation of the natural gas stream comprised of the re-injected condensate stream and of the light hydrocarbon vapor stream. Increasing of the energy of the light hydrocarbon vapor can be achieved by compressing the light hydrocarbon vapor stream and re-injecting the condensate stream into the compressed light hydrocarbon vapor stream, and/or by heating or even vaporizing the condensate stream.

The natural gas processing system can thus be realized by reducing equipment count, plot space and investment costs.

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

When introducing elements of various embodiments the articles “a”, “an”, “the”, and “said” are intended to mean that there are one or more of the elements. The terms “comprising”, “including”, and “having” are intended to be inclusive and mean that there may be additional elements other than the listed elements.

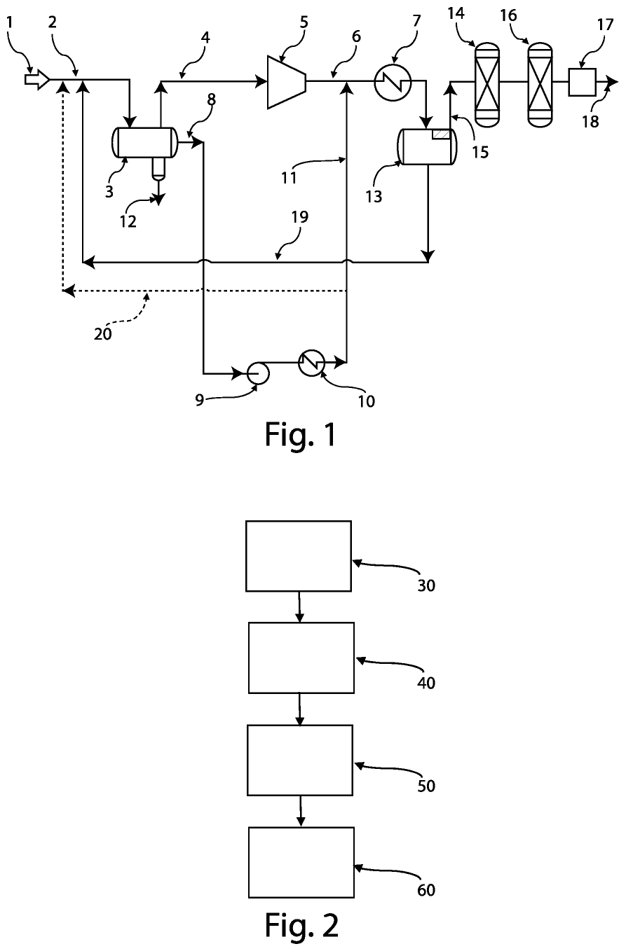

Referring now to the drawings, FIG. 1 shows a schematic of an exemplary natural gas processing system. The natural gas processing system is fed with a natural gas feed 1, which is routed via a natural gas feed line 2 to a three-phase separator 3, wherein the natural gas feed is separated into a light hydrocarbon vapor fraction, a heavy hydrocarbon condensate fraction and a water fraction. A light hydrocarbon vapor stream exits the separator 3 through a vapor line 4, to be routed to a gas compressor 5 and subsequently, through a gas compressor discharge line 6, to a cooler 7 and a knock out drum 13. A heavy hydrocarbon condensate stream exits the separator 3 through a condensate line 8, to be routed to a pump 9 and to a condensate heater 10. Downstream the condensate heater 10, through a heated condensate line 11, the heavy hydrocarbon condensate stream is injected to the gas compressor discharge line 6, upstream the cooler 7. Water is withdrawn from the separator 3 through a water discharge line 12.

From the cooler 7, the natural gas stream, comprising both the heated heavy hydrocarbon condensate stream and the compressed light hydrocarbon vapor streams is directed to the knock out drum 13, via a knock out drum feed line 21. The knock out drum 13 is operated above the natural gas dew point and below the water dew point, to condense only water. A natural gas vapor stream from the knock out drum 13 is routed to a dryer 14 through a dryer feed line 15 and subsequently to a Hg adsorber 16 and to a filter 17, to be finally routed to storage or to a fractionation unit (not shown) through an outlet line 18. Water is recirculated to the natural gas feed line 2 through a water condensate recirculation line 19.

A temperature meter (not shown) is used to control the temperature of the natural gas stream in the knock out drum feed line 21. If the temperature is between the natural gas dew point and the water dew point, then both the cooler 7 and the heater 10 are off. If the temperature is lower than the natural gas dew point, then the heater 10 is used to heat the heavy hydrocarbon condensate stream. If the temperature is higher than the water dew point, then the cooler 7 is used to cool the natural gas stream downstream the re-injection point.

In some embodiments, at least a portion of the heated heavy hydrocarbon condensate from the condensate heater 10 can be withdrawn from the heated heavy hydrocarbon condensate line 11 to be recirculated to the natural gas feed line 2 through a natural gas recirculation line 20.

FIG. 2 shows a flowchart summarizing the method disclosed herein for processing an at least partially condensed natural gas stream prior to storage or fractionation. The natural gas processing method includes the following subsequent steps:
separating (30) an at least partially condensed natural gas stream into a condensate stream and a light hydrocarbon vapor stream;
increasing the energy (40) of the light hydrocarbon vapor stream and/or the condensate stream;
re-injecting (50) the condensate stream into the light hydrocarbon vapor stream; and
controlling (60) the temperature of the natural gas stream.

In some embodiments, the step of increasing the energy (40) of the light hydrocarbon vapor stream and/or the condensate stream includes heating or even at least partly vaporizing the heavy hydrocarbon condensate stream and re-injecting the condensate stream into the light hydrocarbon vapor stream and/or compressing the light hydrocarbon vapor stream and re-injecting the condensate stream into the compressed light hydrocarbon vapor stream.

In some embodiments, the final step of treating (60) the natural gas stream includes at least separating free water and drying. In other embodiments, downstream the step of drying, the final step of treating (60) the natural gas stream includes removing Hg and filtering.

In some embodiments, in order to maintain the temperature of the natural gas stream above the natural gas dew point, before the step of re-injecting (50) the condensate stream into the light hydrocarbon vapor stream, the method disclosed herein comprises a step of heating the condensate stream. In particular, heating is needed in case the ratio between the optionally compressed light hydrocarbons vapor stream and the condensate stream is too low to allow the whole condensate to vaporize when mixing together with the light hydrocarbon vapor stream.

In some embodiments, in order to maintain the temperature of the natural gas stream below the water dew point, the method disclosed herein comprises a step of cooling the natural gas stream after the step of re-injecting (50) the condensate stream into the light hydrocarbon vapor stream. In particular, cooling can be needed in summertime, when the environment temperature is high and heat exchange between the environment and the natural gas stream can cause an undesired heating of the natural gas stream.

In some embodiments, before the step of re-injecting (50) the condensate stream into the light hydrocarbon vapor stream, a step of withdrawing a portion of the condensate stream and recirculating it to the step of separating (30) the at least partially condensed natural gas stream into a condensate stream and a light hydrocarbon vapor stream is provided.

While aspects of the invention have been described in terms of various specific embodiments, it will be apparent to those of ordinary skill in the art that many modifications, changes, and omissions are possible without departing form the spirt and scope of the claims. In addition, unless specified otherwise herein, the order or sequence of any process or method steps may be varied or re-sequenced according to alternative embodiments.

1. A method for processing a natural gas stream, wherein the natural gas stream is at least partially condensed; the method comprising the steps of:
separating the at least partially condensed natural gas stream into a condensate stream and a light hydrocarbon vapor stream;
increasing the energy of the light hydrocarbon vapor stream and/or the condensate stream;
re-injecting the condensate stream into the light hydrocarbon vapor stream; and
controlling the temperature of the natural gas stream, following the step of re-injecting the condensate stream into the light hydrocarbon vapor stream;
wherein the step of increasing the energy of the light hydrocarbon vapor stream and/or the condensate stream is operated according to the step of controlling the temperature of the natural gas stream, following the step of re-injecting the condensate stream into the light hydrocarbon vapor stream, to maintain the temperature of the natural gas stream, following the step of re-injecting the condensate stream into the light hydrocarbon vapor stream higher than the natural gas dew point.

2. The method for processing a natural gas stream of claim 1, wherein said step of increasing the energy of the light hydrocarbon vapor stream comprises the step of compressing the light hydrocarbon vapor stream before the step of re-injecting the condensate stream into the light hydrocarbon vapor stream.

3. The method for processing a natural gas stream of claim 1, wherein said step of increasing the energy of the condensate stream comprises the step of:
pumping the condensate stream before the step of re-injecting the condensate stream into the light hydrocarbon vapor stream.

4. The method of claim 3, wherein the step of increasing the energy of the condensate stream further comprises the step of:
heating the condensate stream before the step of re-injecting the condensate stream into the light hydrocarbon vapor stream.

5. The method of claim 4, wherein the step of increasing the energy of the condensate stream further comprises the step of:
at least partly vaporizing the natural gas of the condensate stream before the step of re-injecting the condensate stream into the light hydrocarbon vapor stream.

6. The method of claim wherein the step of heating the separated stream uses the waste heat of the step of compressing the vapor hydrocarbon stream.

7. The method of claim 1, wherein, if the temperature measured in the step of controlling the temperature of the natural gas stream, following the step of re-injecting the heavy hydrocarbon condensate stream into the compressed light hydrocarbon vapor stream is higher than the water dew point, then the method further comprises the step of:
cooling the natural gas stream after the step of re-injecting the condensate stream into the compressed light hydrocarbon vapor stream.

8. The method of claim 1, wherein after the step of controlling the temperature of the natural gas stream, following the step of re-injecting the heavy hydrocarbon condensate stream into the compressed light hydrocarbon vapor stream, the method includes the steps of:
separating free water from the natural gas stream; and subsequently
drying the natural gas stream.

9. The method of claim 8, further comprising a step of recirculating the separated free water to the step of separating the at least partially condensed natural gas stream into a condensate stream and a light hydrocarbon vapor stream.

10. The method of claim 8, also including the following steps, subsequent to the drying step:
removing Hg from the natural gas stream; and
filtering the natural gas stream.

11. The method of claim 1, further comprising, after the step of separating the at least partially condensed natural gas stream into a condensate stream and a light hydrocarbon vapor stream and before the step of re-injecting the condensate stream into the light hydrocarbon vapor stream, the following steps:
withdrawing a portion of the condensate stream; and
recirculating the withdrawn portion of condensate stream to the step of separating the at least partially condensed natural gas stream into a condensate stream and a vapor natural gas stream.

12. The method of claim 1, further comprising, after the step of separating the at least partially condensed natural gas stream into a condensate stream and a light hydrocarbon vapor stream and before the step of re-injecting the condensate stream into the light hydrocarbon vapor stream, the following step:
separating a water stream from the condensate stream.

13. A system for processing a natural gas stream, the system comprising:
a separator adapted to separate a light hydrocarbon vapor stream and a condensate stream;
a gas compressor adapted to compress the light hydrocarbon vapor stream and/or a heater configured to heat the condensate stream; a pump adapted to increase the pressure of the condensate stream and convey the condensate stream and re-inject the condensate stream through a condensate stream line and into the light hydrocarbon vapor stream in a natural gas stream;
a cooler adapted to cool the temperature of the natural gas stream; and
a temperature control of the natural gas stream, configured to operate the gas compressor and/or the heater and the cooler.

14. The system of claim 13, further comprising a vaporizer, configured to vaporize the condensate stream.

15. The system of claim 13, wherein the heater is arranged downstream the pump (9) along the condensate stream line.
